(19) United States
(12) Patent Application Publication
(10) Pub. No.: US 2026/0099436 A1
(43) Pub. Date: Apr. 9, 2026

(54) REMOTE INTEGRATION OF A TEST DEVICE WITH A CLOUD-BASED TEST BENCH

(71) Applicant: Toyota Jidosha Kabushiki Kaisha, Toyota-shi Aichi-ken (JP)

(72) Inventors: Joshua Scott Smith, Livonia, MI (US); Noriyasu Hashiguchi, Kawasaki city (JP)

(73) Assignee: Toyota Jidosha Kabushiki Kaisha, Toyota-shi Aichi-ken (JP)

(21) Appl. No.: 19/406,278

(22) Filed: Dec. 2, 2025

Related U.S. Application Data
(63) Continuation-in-part of application No. 18/771,089, filed on Jul. 12, 2024.

(51) Int. Cl. G06F 11/3698; G06F 9/50; G06F 11/273; G06F 11/3668

(52) U.S. Cl. CPC G06F 11/3698; G06F 9/5072; G06F 11/2733; G06F 11/3688

(57) ABSTRACT

Systems, methods, and other embodiments described herein relate to a distributed test bench arrangement that permits integration of remote devices. In one embodiment, a method includes receiving, within an orchestrator that controls access to resources of a central test bench, a request to access a requested resource of the resources. The request indicates which of the resources are to be reserved, and a remote device that is to be integrated with the central test bench. The method includes generating a reservation for the request to provide access to the requested resource. The method includes adapting the routing of communications at the central test bench by directing the communications to the remote device to integrate the remote device with the central test bench to form a distributed bench. The method includes executing a test on the distributed bench.

### CROSS-REFERENCE TO RELATED APPLICATIONS

This application is a continuation-in-part of and claims the benefit of U.S. Non-Provisional Application No. 18/771,089, filed on July 12, 2024, which is herein incorporated by reference in its entirety.

### TECHNICAL FIELD

The subject matter described herein relates, in general, to testing electronic devices and, more particularly, to a distributed test bench arrangement that permits integration of remote devices.

### BACKGROUND

Developers implement test benches to provide a controlled environment for developing software for new devices and testing that the new devices function as expected. In general, test benches are built on a per-device basis. As one example, in the context of vehicle electronic control units (ECUs), a test bench may include a custom wire harness that connects various devices together while also providing additional connections for testing purposes. However, the uniqueness of these test benches requires institutional knowledge to effectively use them, thus limiting the ability for these benches to be shared between many developers and complicating access overall. Moreover, as the complexity of the device or arrangement of devices under test increases and/or testing requirements increase, the wiring harnesses also become more complex and difficult to build and maintain. Additionally, the increase in complexity also leads to increased costs for a test setup that is not reusable, thereby leading to further waste.

Moreover, often different developers may be in different locations and may not have direct access to a test bench that includes specific components the developers may need for testing. Also, the developers may work on test devices locally that need to be tested with other components located remotely. However, because of the expense of the various test devices, multiple copies may not be available for distribution. Thus, testing specific components within a complete arrangement of components or against other components with which they interoperate may be difficult.

### SUMMARY

Example systems and methods relate to a distributed test bench arrangement that permits integration of remote devices. As previously noted, test benches can be complex to implement because of various considerations, including the complexity of the device or devices being tested. Moreover, accessing test devices can present a further difficulty, as many devices need to be tested in coordination with other devices that form a larger system. Therefore, in at least one approach, an inventive system is disclosed that provides the ability to utilize a central test bench in combination with a remote device for testing.

In any case, consider that an electronic device, such as an ECU or multiple ECUs, may be implemented at a developer’s local test bench so that the developer can more simply perform various development and testing tasks. However, as part of the development process, the developer is to test the local device in a configuration with devices from other systems that may be integrated into the same overall final product, such as a vehicle. By way of example, the developer may be locally designing and programming an ECU for an infotainment system. The infotainment system does not, however, operate in isolation. Instead, the infotainment system may receive information from other vehicle systems and provide information to other vehicle systems, such as HVAC systems, seat systems, driving systems, and so on. Yet, it is not generally practical for the developer to locally implement the multitude of ECUs that occur with these other systems because they are individually expensive, and other developers also need to perform similar tasks with such ECUs.

Thus, the inventive system leverages a central test bench that is, for example, a cloud-based resource to permit remote testing. The central test bench may be comprised of compute resources, which can implement virtualized ECUs, and hardware ECUs that are separately connected with the central test bench. The central test bench can implement complex designs that include, for example, an entire vehicle, which may be enabled via interface devices connected with hardware ECUs that permit arranging a virtual wire harness between these devices, while also, in at least one arrangement, implementing virtual ECUs within the same ecosystem. Of course, the central test bench itself may be comprised of further resources beyond what is necessary for any single vehicle, however, a vehicle is described as a test scenario for purposes of this discussion.

In any case, the system permits a remote entity (e.g., a developer) with a remote device for testing to reserve resources of the central test bench while further integrating the remote device into a configuration with the central test bench to form a distributed bench. In at least one approach, the remote entity initiates a reservation by communicating a request to an orchestrator of the central test bench. The orchestrator is, for example, an administrative entity that controls access to the central test bench and associated resources. Thus, the orchestrator tracks the availability of the resources and arbitrates access according to different priorities.

In at least one arrangement, the orchestrator receives requests for reservations, such as a request from the remote entity to access a requested resource. The requested resource may be a compute-based resource (e.g., a virtualized ECU) or a hardware-based resource (e.g., a hardware ECU). In any case, the orchestrator parses the request to identify attributes associated with the requested resource and the reservation itself. For example, the orchestrator determines a type of resource, whether the request is for a class of devices (e.g., a particular make/feature) or a specific device (e.g., a specific serial number), a device having a specific error rate, a day/time/length of the reservation, a priority of the request, and so on. In at least one approach, the orchestrator filters tags for the pool of available resources according to the attributes and identifies and selects matching resources that satisfy the request.

Once selected, the orchestrator generates a reservation key and provides the reservation key to the requesting remote entity. The reservation key may be a hash of the attributes of the reservation, a hash of identifiers for reserved resources, or another unique identifier. In any case, the orchestrator generates the reservation by generating the reservation key and adding the reservation to a ledger that controls access to the resources. Thereafter, the remote entity uses the reservation key within a request to initiate the reservation by providing the reservation key along with additional information to the orchestrator. The initiation of the reservation generally involves adapting routing of a virtual wire harness at the central test bench in order to integrate a remote test device of the remote entity with the central test bench to form a distributed bench.

That is, the additional information in the request can include an address of the remote entity along with information about the remote test device. The orchestrator uses the additional information to adapt, for example, a routing table and/or service subscriptions to integrate the remote device, which may be in place of another device at the central test bench. Adapting the routing modifies a virtual wire harness of the central test bench that mimics a real wire harness connecting different components, thereby integrating the remote device as though it were part of the overall system connected by the wire harness. In this way, the orchestrator is able to integrate different components from different locations to form a cohesive distributed test bench. The distributed test bench can then execute a test as directed by the remote entity. The test may take different forms but generally includes integration and validation testing within the context of hardware-in-the-loop (HIL). In any case, after the test is complete, the system can release the reserved resources along with, for example, the remote device to a pool of available resources for use by other entities. In this way, the inventive system is able to improve testing among remote entities and provide a more robust process to better facilitate development.

In one embodiment, a management system is disclosed. The management system includes one or more processors and a memory communicably coupled to the one or more processors. The memory stores a control module that includes instructions that, when executed by the one or more processors, cause the one or more processors to receive, within an orchestrator that controls access to resources of a central test bench, a request to access a requested resource of the resources. The request indicates which of the resources are to be reserved, and a remote device that is to be integrated with the central test bench. The instructions include instructions to generate a reservation for the request to provide access to the requested resource. The instructions include instructions to adapt routing of communications at the central test bench by directing the communications to the remote device to integrate the remote device with the central test bench to form a distributed bench. The instructions include instructions to execute a test on the distributed bench.

In one embodiment, a non-transitory computer-readable medium including instructions that, when executed by one or more processors, cause the one or more processors to perform one or more functions is disclosed. The instructions include instructions to receive, within an orchestrator that controls access to resources of a central test bench, a request to access a requested resource of the resources. The request indicates which of the resources are to be reserved, and a remote device that is to be integrated with the central test bench. The instructions include instructions to generate a reservation for the request to provide access to the requested resource. The instructions include instructions to adapt routing of communications at the central test bench by directing the communications to the remote device to integrate the remote device with the central test bench to form a distributed bench. The instructions include instructions to execute a test on the distributed bench.

In one embodiment, a method is disclosed. The method includes, in at least one arrangement, receiving, within an orchestrator that controls access to resources of a central test bench, a request to access a requested resource of the resources. The request indicates which of the resources are to be reserved, and a remote device that is to be integrated with the central test bench. The method includes generating a reservation for the request to provide access to the requested resource. The method includes adapting routing of communications at the central test bench by directing the communications to the remote device to integrate the remote device with the central test bench to form a distributed bench. The method includes executing a test on the distributed bench.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of an interface system that is associated with an adaptable platform for testing electronic devices.

FIG. 2A illustrates one embodiment of an interface device and connected devices.

FIG. 2B illustrates one embodiment of the interface device of FIG. 2A with additional details illustrated.

FIG. 3 illustrates a flowchart of communications between an interface device and a test service.

FIG. 4 is a flowchart representing a method associated with using an interface device to mediate communications with a device under test.

FIG. 5 illustrates one configuration of an edge service that includes multiple interface devices.

FIG. 6 illustrates one configuration of a cloud-based service that utilizes interface devices to provide emulation of physical wire harnesses.

FIG. 7 is a flowchart illustrating a method associated with emulating a wire harness.

FIG. 8 is a diagram illustrating one arrangement of a rack system that houses multiple networks of interface devices.

FIG. 9 illustrates one embodiment of a management system that is associated with arbitrating access to resources of a central test bench.

FIG. 10 illustrates one arrangement of a rack system that embodies a central test bench and remote entities that may access the rack system.

FIG. 11 is a flowchart illustrating a method associated with a distributed test bench that permits integration of remote devices.

### DETAILED DESCRIPTION

Systems, methods, and other embodiments associated with a distributed test bench that permits integration of remote devices are disclosed. As previously noted, test benches can be complex to implement because of various considerations, including the complexity of the device(s) being tested. Moreover, access to test benches can further complicate testing during development. This leads to increased costs and waste since these test benches are complex to implement and are unique to the particular instance, thereby not being reusable. By way of example, within the context of a vehicle, a wiring harness may connect with a dozen or more electronic control units. Each of the electronic control units (ECUs) undergoes development and testing to implement particular functionality in the vehicle in a manner that the developers desire. Thus, each different configuration of systems within a vehicle during development and each separate iteration of different ECUs that may be selected requires a new wiring harness to be manually fabricated. Consequently, the ability to iterate designs when developing a new platform can be costly, thereby potentially limiting development.

Therefore, in at least one approach, an inventive system is disclosed that provides an adaptable interface and associated logic to improve the testing of electronic devices. For example, in at least one aspect, an interface device is comprised of a controller, a memory, a bridge, and a connector for supporting communication with a device under test (i.e., an electronic device, which is also referred to as a test device herein). The electronic device may take many different forms, including a module with multiple die packages, a single die package, a system on a chip (SoC), and so on. As described herein, the electronic device is generally an electronic control unit (ECU) as may be used within a vehicle. It should be appreciated that while the present disclosure focuses on the context of a vehicle, the disclosed devices, systems, and methods are applicable to other contexts and the discussed context should not be construed as limiting.

In any case, consider that an electronic device, such as an ECU or multiple ECUs are generally connected using a complex wiring harness when installed within a vehicle. The wiring harness may include a connector for each separate ECU with wiring therebetween. Moreover, within the context of testing, the wire harness may be further implemented to include diagnostic connectors for providing diagnostic signals. However, as noted previously, specifically designing a unique wiring harness for each different configuration of electronic devices that may need to be tested is complex. As such, the interface device resolves this issue by using the bridge to connect with multiple electronic devices under test, such as multiple different ECUs. The bridge connects to a respective electronic device via a connector pins. The connector pins connect the bridge with an explicit connector port associated with the electronic device being tested (e.g., an ECU) or directly to pins of a die package or other electronic device (e.g., sensor).

Consequently, the connector pins may be specific to the particular electronic device, but this is in place of a more complex harness that cannot be modified for different arrangements. Because the connector pins from the bridge to the electronic device is unique in each instance, the interface device further includes a memory, which may be an EEPROM or similar type of non-volatile memory, that stores configuration information about the electronic device and other devices under test that are connected via other connector pins to the bridge. The contents of the configuration information may vary by implementation but generally include descriptive data identifying the electronic device (e.g., serial number or other identifier, version number, etc.) and a mapping of the connector pins. The mapping identifies the correlation of the pins of the electronic device with the ports of the bridge on which the pins are connected and exposed for communication. Accordingly, a controller mediates access to the electronic device by communicating the configuration information so that a test server or other test administering device can access the electronic device via the bridge by using the mapping.

In various further arrangements, the interface device communicates with an edge service and/or a cloud service. The edge service may function over a network connection with the interface device to aggregate configuration information from multiple different interface devices that connect with different electronic devices. Thus, the edge service may connect with the interface device via an ethernet switch or communication network and functions to acquire the configuration information for a set of electronic devices associated with different interface devices. As a result, the edge service generates a mapping of the set of electronic devices and the associated connections provided via the respective bridges. A testing system can then use the edge service to form a virtual wire harness through the use of the mapping to emulate connections between the different electronic devices. That is, the edge service can provide for connecting the different electronic devices via the interface devices in a similar manner as would occur with a physical wire harness but without the complexity and waste of implementing the wire harness.

Moreover, a cloud service may further aggregate mappings from multiple edge services to provide additional functionality, such as mimicking a wire harness of a vehicle. The cloud service can provide access for remote clients in addition to permitting additional functionality, such as the provisioning of more complex virtual harnesses between separate edge services, reservations for scheduling testing among different entities, data analytics, and so on. In yet further arrangements, the cloud-based service can integrate remote test devices into a central test bench to provide a distributed test bench for testing the remote test device against other components. In this way, the disclosed approach is able to improve testing of electronic devices by avoiding complex, expensive, and potentially wasteful physical harnesses for testing.

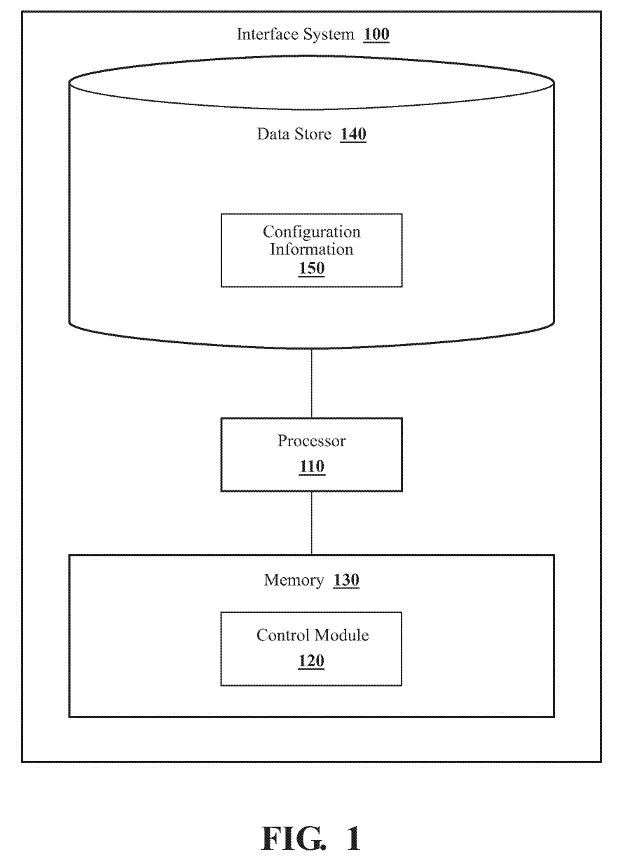

With reference to FIG. 1, one embodiment of an interface system 100 is illustrated. The interface system 100 is shown as including a processor 110, which may be integrated within the interface system 100 or may be associated with a separate computing device, such as a server, cloud-computing system, and so on. Accordingly, the processor 110 may be a part of the interface system 100, or the interface system 100 may access the processor 110 through a data bus or another communication path. In one embodiment, the interface system 100 includes a memory 130 that stores a control module 120. The memory 130 is a random-access memory (RAM), read-only memory (ROM), a hard-disk drive, a flash memory, or another suitable memory for storing the module 120. The module 120 is, for example, computer-readable instructions that, when executed by the processor 110, cause the processor 110 to perform the various functions disclosed herein. In alternative arrangements, the module 120 is independent from the memory 130 and is, for example, comprised of hardware elements (e.g., arrangements of logic gates). Thus, the module 120 is alternatively an ASIC, a hardware-based controller, a composition of logic gates, or another hardware-based solution.

The interface system 100, as illustrated in FIG. 1, is an abstracted form of the interface system 100 as may be implemented as part of an interface device, an edge service, and/or a cloud-computing system. It should be appreciated that the functionality discussed in relation to the interface system 100 may be wholly retained within a single device, such as the interface device itself, or may be distributed among multiple different devices, such as interface devices, computing elements functioning as edge services, computing elements functioning as cloud services, and so on. As such, the particular arrangement described in relation to FIG. 1 is not intended to be limiting but as an example of how the specific functions described herein may be executed in relation to a computing device.

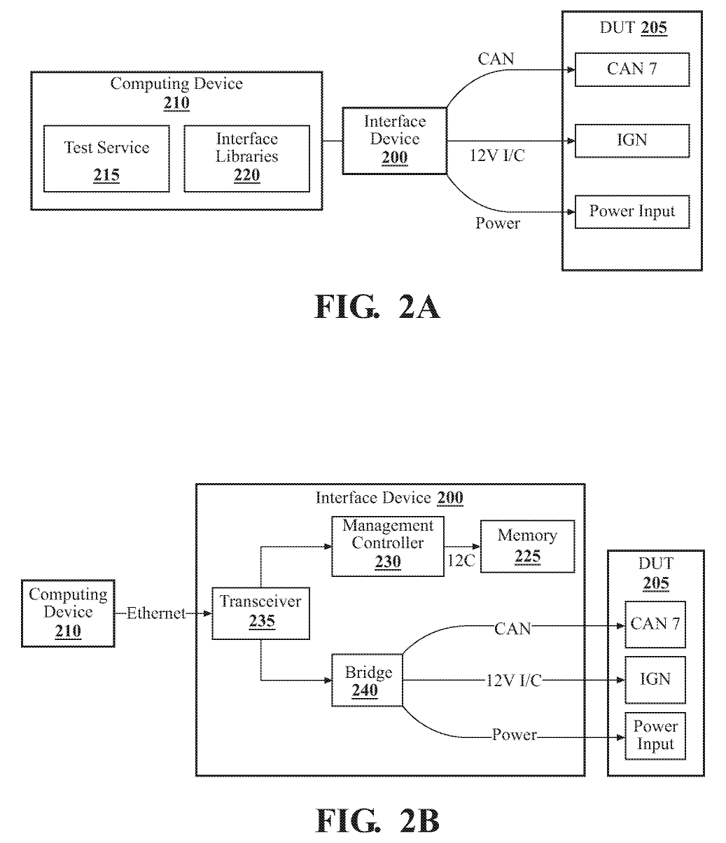

With reference to FIG. 2A, one example of an interface device 200 (also referred to as a hardware interface (HWI) herein) is illustrated. The interface device 200, as shown, connects with a device under test (DUT) 205. The DUT 205 may, in general, be any electronic device that is being tested, such as an ECU, or other electronic module. The interface device 200 connects with the DUT 205 via a connector pins that is specific to the DUT 205. As illustrated in the present example, the connector pins includes three primary connections that may be comprised of multiple separate wires each. In particular, the DUT 205 is connected via a control area connection (CAN), a 12 V I/O, and a power line. These separate portions of the connector pins interface with a CAN port, and IGN port, and a power input, respectively. Thus, as can be appreciated from the present example, the connector pins for each separate DUT may be unique to that DUT and is, therefore, implemented, in at least one arrangement, on a per-device basis. As an additional aspect, while the interface device 200 is shown in FIG. 2A as connecting with a single DUT 205, in various arrangements, the interface device 200 is capable of connecting multiple separate DUTs. The number of devices to which the interface device 200 connects is generally only limited by attributes of hardware included within the interface device 200 itself, such as a communication bridge that may have a certain number of ports within which to connect.

Separately, the interface device 200, in the illustrated example, connects with a computing device 210. The computing device 210 is, in one or more configurations, a server, a desktop computer, a laptop, or another device that is capable of executing instructions for testing the DUT 205 and communicating via the interface device 200. The computing device 210 executes a test service 215 that includes instructions for testing the DUT 205. For example, the test service 215 may include instructions to provide automated testing and/or a manual interface to the DUT for manual testing. The testing may take different forms depending on the particular use, but can include diagnostics testing, development of software for use on the DUT 205, debugging, and so on.

In any case, the test service 215 uses interface libraries 220 to provide for interfacing with the interface device 200 and the DUT 205. That is, the interface libraries 220 may form an application program interface (API) or other software library that provides functions for facilitating communications between the computing device 210 and the interface device 200 over an Ethernet connection or other electronic communication link. For further details of the interface device 200, consider FIG. 2B, which shows additional components of one example of the interface device 200 of FIG. 2A. As illustrated, the interface device 200 includes a memory 225, a management controller 230, a transceiver 235, and a bridge 240.

The transceiver 235 provides for communicating over an Ethernet connection or other communication link with the computing device 210 and may further route communications within the interface device 200 itself. For example, depending on the request provided by the computing device 210 via the interface libraries 220, the transceiver 235 may route the communication to the management controller 230 or directly to the bridge 240. The management controller 230 may be an ASIC, logic, or other programmable processing device that handles initialization requests from the computing device 210 or another external device. For example, the management controller 230 may receive an initialization request for information about one or more DUTs connected to the interface device 200. In general, the interface device 200 stores configuration information (e.g., configuration information 150 within the data store 140) for each DUT that is connected with the interface device 200. The interface device 200 may store the configuration information in the memory 225. The memory 225 is, for example, an EEPROM, or other non-volatile memory.

The configuration information stored in the memory 225 includes information about the DUT 205 and the connector pins that connects the DUT 205 with the bridge 240. The information about the DUT 205 can include a device identifier, version number, and other attributes (e.g., device specifications, such as memory, processing capabilities, etc.). The connector pins information includes a mapping or listing of how the pins of the DUT 205 are connected with the bridge 240. Thus, the pin information correlates the pins to ports of the bridge 240 so that the requesting device (i.e., the computing device 210) can generate a mapping for subsequently powering, controlling, and otherwise communicating with the DUT 205. Accordingly, the test service 215 uses the interface device 220 to build a mapping that provides for routing signals generated by the test service 215 when executing a test program to the appropriate pins of the DUT 205. In general, the mapping defines ports associated with the bridge 240 for communicating signals on particular pins of the DUT 205. In this way, the interface device 200 exposes the DUT 205 for interactions with external devices.

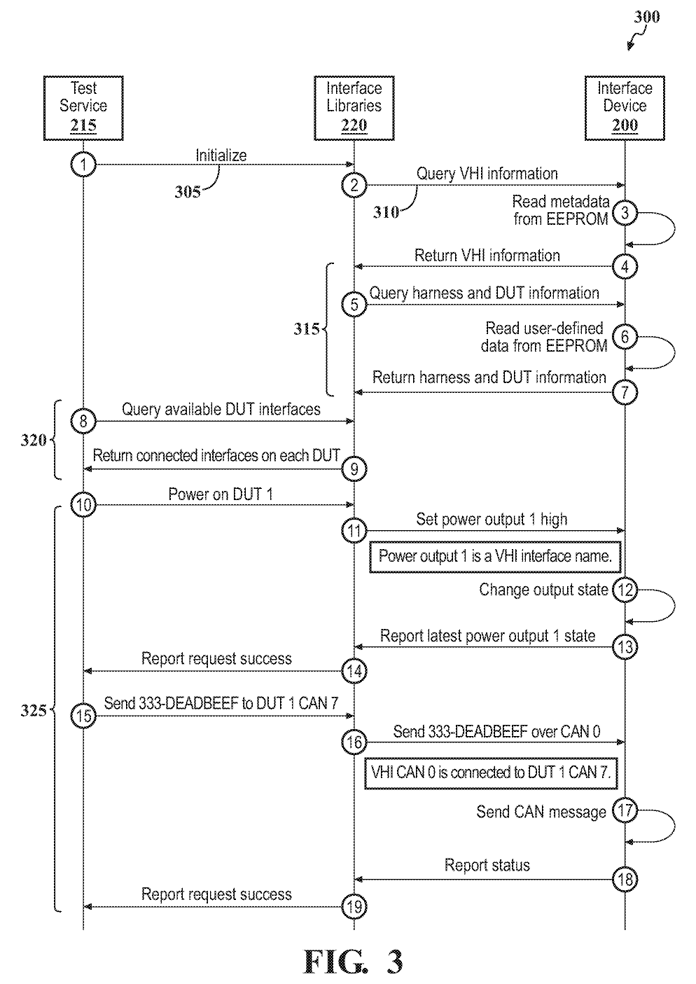

Continuing to FIG. 3, an example 300 of communications between the test service 215, the interface library 220, and the interface device 200 are represented. As additional context, the test service 215 is, in at least one arrangement, an automated testing program that provides a defined set of inputs to the DUT 205 while recording responses in order to characterize the performance of the DUT 205 (e.g., whether the DUT 205 is operating as expected). In further arrangements, the test service 215 may be a development environment for generating software code and loading the software code into the DUT 205 for execution. In still further arrangements, the test service 215 is a manual testing interface that allows a user to select inputs to provide directly to the DUT 205. In yet further arrangements, the test service 215 is a client for interfacing with external requests from remote applications. For example, the test service 215 may interface with an edge service, a cloud-based service, or another entity in order to provide access to the DUT 205 or other attached DUTs of the interface device 200.

In any case, the test service 215 initiates communication with the interface device 200 at 305. In order to provide the communication in the appropriate form, the interface libraries 220, which may be implemented as instructions executing as part of the test service 215, process the request into a query to the interface device, as shown at 310. Responsive to the query, the interface device 200 via the management controller 230 acts to retrieve the configuration information from the memory 225 and communicate the configuration information back to the interface libraries, which is shown as a multistep process at 315. While shown as being retrieved over multiple steps, in various arrangements, the interface device 200 may provide contents of the configuration information in a single communication or in multiple communications depending on, for example, buffer sizes and/or other hardware constraints.

The interface libraries 220 then function to generate the mapping of the pins of the DUT 205 connected with the interface device 200 so that the interface library 220 can translate requests from the test service 215 and communicate the requests on the appropriate ports of the bridge 240. In any case, once the interface libraries 220 function to initialize the mapping, which may be implemented as list, a table, or another data structure that correlates the ports with the pins, the test service 215 is able to query the interface libraries 220 for information about the DUT 205, as shown at 320, such as an identifier, version number, connected pins/interfaces available with the DUT 205, and so on. It should be appreciated that while a single DUT 205 is described, in further arrangements, the information returned from the interface device 200 may include multiple DUTs. Thus, the interface libraries 220 may then function to provide information about multiple separate DUTs. FIG. 3 further illustrates how the test service 215 proceeds to interact with the DUT 205 via the interface device 200. The illustrated communications generally involve powering the DUT 205, communicating with the DUT 205, and acquiring diagnostic information, such as status reports from the DUT 205 via the connected pins.

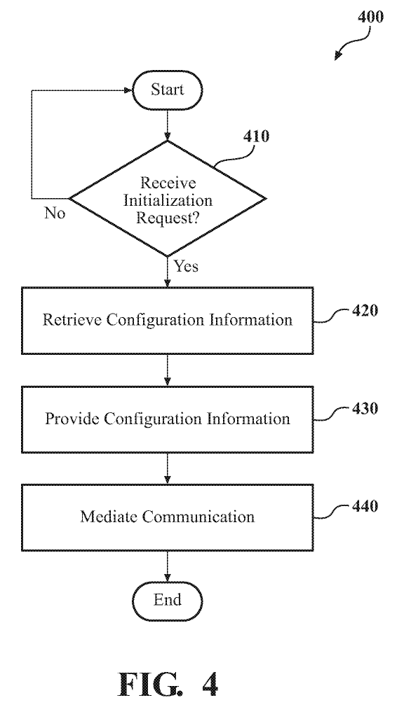

Additional aspects of using an interface device to facilitate communications for testing will be discussed in relation to FIG. 4. FIG. 4 illustrates a flowchart of a method 400 that is associated with adaptably interfacing with a device under test (DUT). Method 400 will be discussed from the perspective of the interface system 100 of FIG. 1 with further reference to the interface device 200 of FIGS. 2A-B. While method 400 is discussed in combination with the noted elements, it should be appreciated that the method 400 is not limited to being implemented within the interface system 100 but is instead one example of a system that may implement the method 400.

At 410, the control module 120 monitors for requests from a device connected with the interface device 200. For example, the interface device 200 may connect directly with another device or may connect with a network on which multiple different devices may communicate. In various arrangements, the interface device 200 connects with the network or directly to the other device via an Ethernet cable or other suitable communication link. In any case, the control module 120, which may be implemented, at least in part, as the management controller 230 monitors for communications and identifies or otherwise distinguishes between different communications. In one approach, the control module 120 monitors for a particular flag in the communication or otherwise parses the communication to determine if the communication is an initialization request to access a test device (i.e., DUT) that is connected with the bridge 240. If the communication is an initialization request, then the control module 120 proceeds to retrieve configuration information, as discussed at 420. Otherwise, the control module 120 continues to monitor the communications.

At 420, the control module 120 retrieves configuration information from a memory within the interface device 200. As previously described, the memory 225 stores configuration information for devices connected to the bridge 240 of the interface device 200. Thus, the memory 225 may store a different selection of configuration information depending on how many devices are connected with the interface device. As such, the control module 120, depending on the implementation, may retrieve the configuration information for all of the attached devices or for device(s) specified in the request. Thus, the control module 120 may parse the request to identify attributes of the request, which generally include the DUTs for which information is being requested. Of course, in alternative arrangements, the control module 120 may simply retrieve information for all DUTs for which configuration information is present in the memory 225.

At 430, the control module 120 provides the configuration information in response to the request. That is, the control module 120 (i.e., the management controller 230) communicates the retrieved configuration information to the requesting device via the transceiver 235. As outlined previously, the configuration information includes at least information that permits the requesting device (e.g., a client instance of the control module 120 executing on the computing device 210) to generate a mapping of pins of the test device for communicating with the test device over the network connection. The mapping then functions to facilitate communication with the test device.

At 440, the control module 120 mediates access to the test device(s). That is, for example, the control module 120 via the management controller 230 and the interface libraries 220 functions to control how the communications are routed to the test device(s). In various arrangements, the control module 120 simply leverages the generated mapping to provide communications to a particular DUT. However, in further arrangements, the control module 120 functions to emulate a wire harness. That is, when multiple separate DUTs are connected with the interface device 200 or with multiple interface devices as discussed further subsequently, the control module 120 can emulate a wire harness by directing the communications as though the test devices are wired in the same manner as if a physical wire harness between the test devices was present.

For example, signals generated by one test device (i.e., DUT 205) can be routed to another test device as though the devices are connected via a physical wire harness. However, the control module 120 instead functions to receive and relay the communications. This permits the control module 120 to emulate any configuration of test devices while further collecting diagnostic/analytics data about how the test devices are functioning. Moreover, the control module 120 can further extend an emulated wire harness among multiple interface devices in order to permit more complex arrangements.

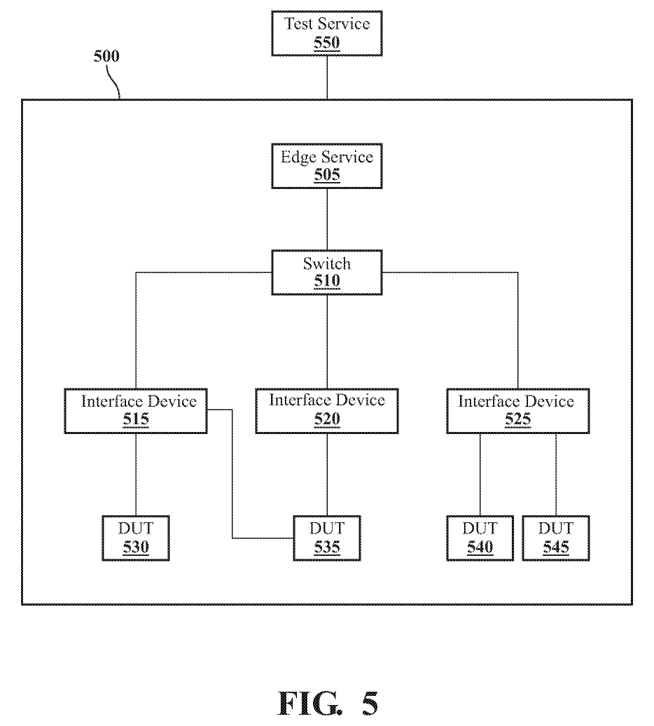

In that regard, consider FIG. 5, which illustrates an edge network 500. The edge network 500 is comprised of an edge service 505, which is generally similar to the computing device 210 of FIG. 2, a switch 510, and multiple interface devices 515, 520, and 525. The interface devices are configured in a similar manner as the interface device 200 of FIG. 2. However, as shown in the edge network 500, the arrangement of DUTs 530, 535, 540, and 545 is distinct from the previous example. In particular, the interface devices 515 and 520 are shown as sharing connections with the DUT 535. This example illustrates how the interface devices 515 and 520 are adaptable to different arrangements. In particular, the interface device 515 may provide for connecting with a portion of the pins of the DUT 535 while the interface device 520 may connect with different pins of the DUT 535. This circumstance may arise in different configurations due to, for example, the DUT 535 including more pins than what can be accommodated by a single interface, to split bandwidth between the separate interface devices 520, as a logical division of functions of the DUT 535 for improved management by the interface devices, and so on.

As one example, the DUT 535 may be a complex module that includes connections with multiple sensors, such as multiple cameras. Moreover, the DUT 535 may further include processing capabilities, management, and other functionality built into multiple different electronic components included therein. As such, the pins associated with the separate functions or in any combination that is desired can be divided between the two interface devices 515 and 520. In this arrangement, the interface devices 515 and 520 separately include configuration information for the pins connected to each individual device and also, in at least one arrangement, general identifying information (e.g., serial number, version number, etc.) for the DUT 535. In this arrangement, the interface device 515 still services the DUT 530 in the same manner as previously described. Accordingly, the ability to split the pins between separate interface devices provides additional flexibility in emulating a wire harness.

The edge network 500 provides for the edge service 505 managing the interface devices 515, 520, and 525. That is, the edge service 505 may function to aggregate information from the interface devices 515-525 in order to simplify access on the part of a test service 550. The test service 550 may be a remote client instance that communicates with the edge service 505 in order to perform automated tests and/or other functions on the DUTs 530-545 either individually or in a particular arrangement (e.g., via an emulated wire harness). Thus, the edge service 505 can be configured to perform various management functions, including implementing the interface libraries 220. In this way, the edge network 500 provides for implementing more complex arrangements of DUTs and also provides access to a wider variety of devices. Moreover, devices within an individual edge network are generally co-located, while separate edge networks may be physically distant and located remotely. In various arrangements, a cloud service, which is described in greater detail subsequently, may schedule jobs (i.e., access to particular DUTs to perform testing) within a single edge network, as opposed to spanning multiple edge networks, when feasible. This may provide for executing multiple copies of a test on separate edge networks in parallel. Of course, in further arrangements, virtual wire harnesses can be implemented, and tests performed in configurations that span multiple edge networks.

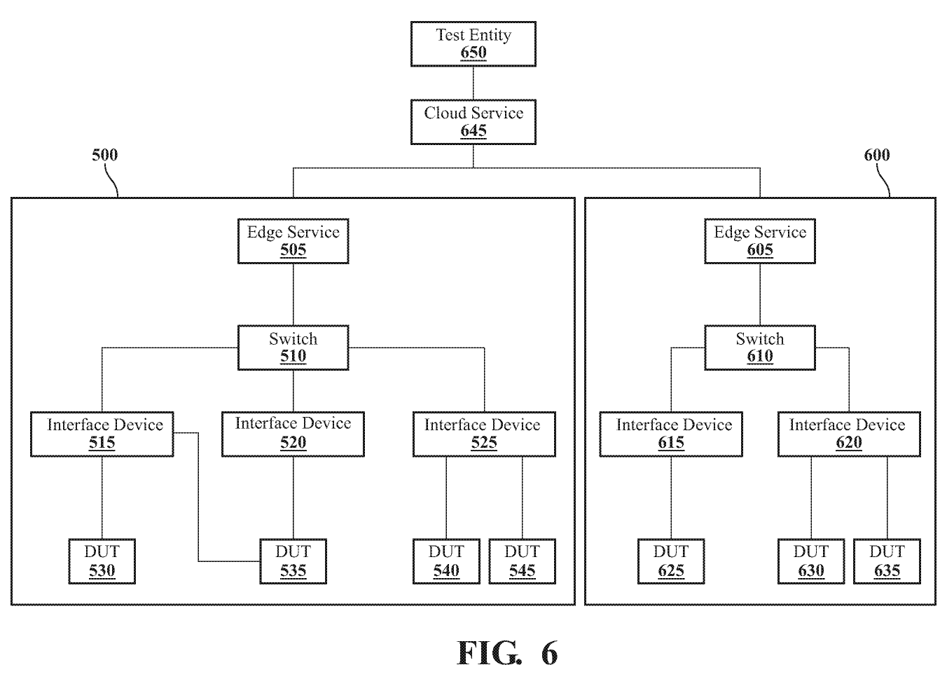

Continuing further with additional implementations of edge services, consider FIG. 6. FIG. 6 illustrates an example implementation of a cloud-based arrangement. As shown in FIG. 6, the edge network 500 functions in parallel with an additional edge network 600. In general, the overall configuration of the edge networks 500 and 600 is similar, except that the number of interface devices and the attached DUTs may vary depending on the particular implementation. For example, the edge network 600 is shown with an edge service 605 and a switch 610, which is similar to the edge network 500. However, the edge network 600 includes two interface devices 615 and 620 with associated DUTs 625, 630, and 640. In further examples, the number of interface devices per edge network may vary to include more or fewer as well as including more or fewer DUTs.

Additionally, a cloud service 645 is shown connected with the edge networks 500/600. The cloud service 645 may provide connections with more or fewer edge networks than shown in the present example. It should be appreciated that the present example is shown for illustrative purposes and should not be construed as limiting the overall structure. In any case, the cloud service 645 further functions to aggregate information about the DUTs within the connected interface devices of the networks 500/600. The cloud service 645 may be a service executing within a cloud-based device (e.g., a computing server) that is connected with a wide area network, the Internet, or another network for providing communications between remote devices. As such, the cloud service 645 functions to provide access to the DUTs via the connected networks and may further provide additional functions. For example, the cloud service 645 may provide reservations for accessing the DUTs, automatic interface, DUT, and emulated harness registration for access by remote clients, statistics/analytics reporting, native interface bridging, and so on.

In further arrangements, the cloud service 645 provides for bridging together the interfaces from the separate networks to emulate a wire harness. Stated otherwise, the cloud service 645 aggregates the information from the separate interface devices dispersed across the separate edge networks (e.g., 500 and 600) and can form a virtual wire harness between selected ones of the available DUTs. The cloud service 645 provides access for a test entity 650 that may include automated tests, developers, and/or other networked entities. In general, the cloud service 645 provides additional layers of functionality on top of the interface devices and the edge services, as previously described.

As one example, the cloud service 645 can provide access for the test entity 650, which may be a testing device executing testing software that supports hardware-in-loop (HILS), software-in-loop (SILS), simulated electronic control units (ECUs) connected via a virtual wire harness, and so on. Thus, the cloud service 645 can provide access to the DUTs 530-545 and 625-635 and/or virtual/emulated wire harnesses, including the DUTs 530-545 and 625-635. As such, the test entity 650, in one or more approaches, uses the cloud service 645 to form more complex virtual wire harnesses that can include emulated entities (e.g., ECUs) and can also provide access for various software routines. In this way, the cloud service 645 provides interface bridging that enables complex test bench setups and multiple interconnected ECUs to be dynamically provisioned without physical vehicle wire harnesses. Thus, instead of implementing a single large test bench with many ECUs connected via physical wiring, each separate ECU can be installed as a DUT in a server rack associated with an interface device and can be dynamically connected via an emulated wire harness to other ECUs, thereby providing for rapid testing across many different wire harnesses or vehicle variants.

Moreover, the cloud service 645 accepts and manages reservations for a set of DUTs (e.g., ECUs). In general, the cloud service 645 queues requests for jobs (e.g., testing) such that usage of the separate DUTs at the different edge networks managed by the cloud service 645 are maximized. Once a reservation sis granted, the cloud service 645 manages access for a requesting party to one or more edge services so that the requesting party can connect with interfaces and route traffic to and from the interfaces. The cloud service 645 may implement this service in different forms. For example, in a first approach, the cloud service 645 arranges for an associated edge service to bridge all traffic between the requesting party and the DUT (e.g., ECU) via a GRPC or other remote session protocol. The edge service is then enabled to fully control the connection to prevent malicious actors from accessing the ECU without a reservation. In a separate approach, the cloud service 645 manages the edge service to provide routing services (e.g., as an IP address and port), then the requesting party can directly connect to the ECU with the IP address and port information.

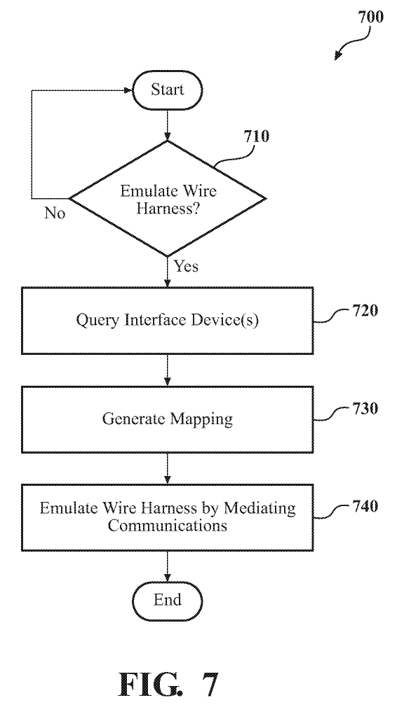

Additional aspects of using an interface device within a cloud services context will be discussed in relation to FIG. 7. FIG. 7 illustrates a flowchart of a method 400 that is associated with emulating a wire harness. Method 700 will be discussed from the perspective of the interface system 100 of FIG. 1 with further reference to the cloud service 645 of FIG. 6. While method 700 is discussed in combination with the noted elements, it should be appreciated that the method 700 is not limited to being implemented within the interface system 100 but is instead one example of a system that may implement the method 700.

At 710, the control module 120 monitors for requests from a device. The device may be the test entity 650, the test service 550, or another computing entity (e.g., a test server) that is attempting to access one or more DUTs. In particular, the request, in at least one arrangement, is in regards to emulating a wire harness. As described herein, emulating a wire harness or, stated otherwise, provisioning a virtual wire harness involves mapping available DUTs connected via interface devices to a network and routing communications therebetween according to virtual associations defined by the emulated wire harness.

Accordingly, the request may indicate a form of the wire harness and different DUTs that are to be connected. As such, the control module 120, which may execute as a client instance as part of the cloud service 645, monitors for the requests via a communication link. Once received, the control module 120 proceeds to perform additional functions in support of emulating the wire harness. Otherwise, the control module 120 proceeds with monitoring at 710.

At 720, the control module 120 queries the interface device(s). In at least one approach, the control module 120 provides queries to each separate interface device to retrieve configuration information for the multiple test devices (i.e., DUTs) that are to be virtually connected via the wire harness. In a further arrangement, the control module 120 instead queries edge services (e.g., 505, 605), which can store aggregated information from the interface devices about available DUTs. In any case, the control module 120 queries the respective entities and aggregates the configuration information in response. As previously noted, the configuration information includes information about the respective DUT (e.g., part number, serial number, etc.) and further includes information about the ports of the bridge to which the pins of the DUT are connected, which provides for facilitating communication with the DUT.

At 730, the control module 120 generates a harness mapping that identifies connections through respective interface devices. In particular, the control module 120 uses the configuration information acquired from the interface devices to define correlations between the DUTs via the port-to-pin correlations. That is, the control module 120, in one arrangement, generates a table, such as a routing table, that indicates which pins should provide signals to other specific pins of different DUTs as would be connected with a physical wire if the harness was physically connected. However, because the harness is being emulated and is virtual, the connections are represented through the harness mapping, which may take the form of a routing table. In this way, the control module 120 is able to emulate any arrangement of devices by simply providing a specific routing configuration between the pins of the devices under test.

At 740, the control module 120 emulates the wire harness. As previously described, the emulation may be performed at the cloud service 645 or the edge service (e.g., 505 or 605). In general, the service that provides the emulation simply permits a different scope of interaction with different interface devices. In particular, the cloud service 645 permits access across multiple edge networks while the edge service is limited to the interface devices connected within the particular network. In any case, the control module 120 can have separate instances executing within the different services to provide for the emulation functionality. Thus, the control module 120 uses the harness mapping to mediate communications between the separate DUTs that are included within a virtual wire harness. In one or more approaches, mediating the communications includes the control module 120 routing signals between the DUTs according to the harness mapping. Thus, the control module 120 identifies the source of the communication (i.e., a particular signal from a particular DUT) and routes the signal to one or more other DUTs according to the harness mapping. In this way, the interface system 100 is able to emulate a wire harness and provide an adaptable test bench environment that overcomes the limitations of physical arrangements.

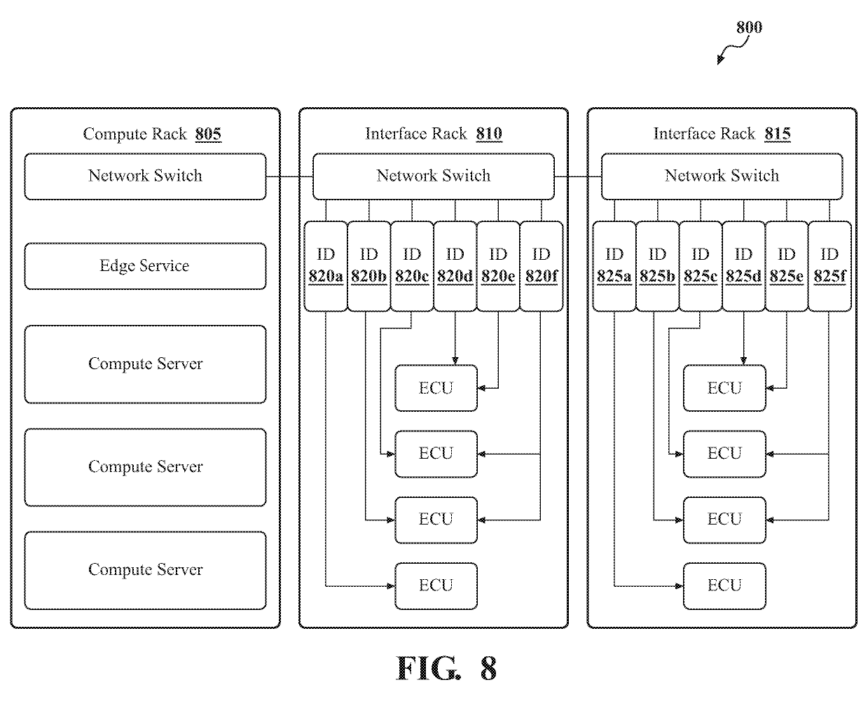

With reference to FIG. 8, one example of a rack system 800 is illustrated as it may be installed within a server. In particular, the rack system 800 is comprised of three primary elements, including a compute rack 805, an interface rack 810, and an interface rack 815. The compute rack 805 includes a network switch to connect with a network to which the other racks 810 are also connected. The compute rack 805 further includes multiple compute servers and an edge service. The compute servers may execute various instances of the interface system 100 and/or different test services (e.g., test service 215, test service 550, test entity 650). Thus, the automated test programs and other software that may interact with the interfaces can be executed on the compute rack 805. The interface racks 810 and 815 have similar configurations that include network switches to connect with the network and communicate with the compute rack 805. To the network switches, the interface racks 810 connect multiple interface devices, which are labeled ID 820a-f and 825a-f to associated ECUs that are devices under test. As such, the rack system 800 provides for implementing complex virtual wire harness via edge and cloud services executing on the compute rack 805. In this way, the adaptable interfaces (e.g., 820a-f, 825a-f) improve the testing process by avoiding complexities associated with physical harnesses.

Now, consider a further approach involving a central test bench. In at least one arrangement, a management system leverages a central test bench that is, for example, a cloud-based resource to permit remote testing. The central test bench may be comprised of compute resources, which can implement virtualized ECUs, and hardware ECUs that are separately connected with the central test bench. The central test bench can implement complex designs that include, for example, an entire vehicle, which may be enabled via interface devices connected with hardware ECUs that permit arranging a virtual wire harness between these devices, while also, in at least one arrangement, implementing virtual ECUs within the same ecosystem.

The system permits a remote entity (e.g., a developer) with a remote device for testing to reserve resources of the central test bench while further integrating the remote device into a configuration with the central test bench to form a distributed bench. In at least one approach, the remote entity initiates a reservation by communicating a request to an orchestrator of the central test bench. The orchestrator is, for example, an administrative entity that controls access to the central test bench and associated resources. Thus, the orchestrator tracks the availability of the resources and arbitrates access according to different priorities.

In at least one arrangement, the orchestrator receives requests for reservations, such as a request from the remote entity to access a requested resource. The requested resource may be a compute-based resource (e.g., a virtualized ECU) or a hardware-based resource (e.g., a hardware ECU). In any case, the orchestrator parses the request to identify attributes associated with the requested resource and the reservation itself. For example, the orchestrator determines a type of resource, whether the request is for a class of devices (e.g., a particular make/feature) or a specific device (e.g., a specific serial number), a device having a specific error rate, a day/time/length of the reservation, a priority of the request, and so on. In at least one approach, the orchestrator filters tags for the pool of available resources according to the attributes and identifies and selects matching resources that satisfy the request.

Once selected, the orchestrator generates a reservation key and provides the reservation key to the requesting remote entity. The reservation key may be a hash of the attributes of the reservation, a hash of identifiers for reserved resources, or another unique identifier. In any case, the orchestrator generates the reservation by generating the reservation key and adding the reservation to a ledger that controls access to the resources. Thereafter, the remote entity uses the reservation key within a request to initiate the reservation by providing the reservation key along with additional information to the orchestrator. The initiation of the reservation generally involves adapting routing of a virtual wire harness at the central test bench in order to integrate a remote test device of the remote entity with the central test bench to form a distributed bench.

That is, the additional information in the request can include an address of the remote entity along with information about the remote test device. The orchestrator uses the additional information to adapt, for example, a routing table and/or service subscriptions to integrate the remote device, which may be in place of another device at the central test bench. Adapting the routing modifies a virtual wire harness of the central test bench that mimics a real wire harness connecting different components, thereby integrating the remote device as though it were part of the overall system connected by the wire harness. In this way, the orchestrator is able to integrate different components from different locations to form a cohesive distributed test bench. The distributed test bench can then execute a test as directed by the remote entity. The test may take different forms but generally includes integration and validation testing within the context of hardware-in-the-loop (HIL). In any case, after the test is complete, the system can release the reserved resources along with, for example, the remote device to a pool of available resources for use by other entities. In this way, the inventive system is able to improve testing among remote entities and provide a more robust process to better facilitate development.

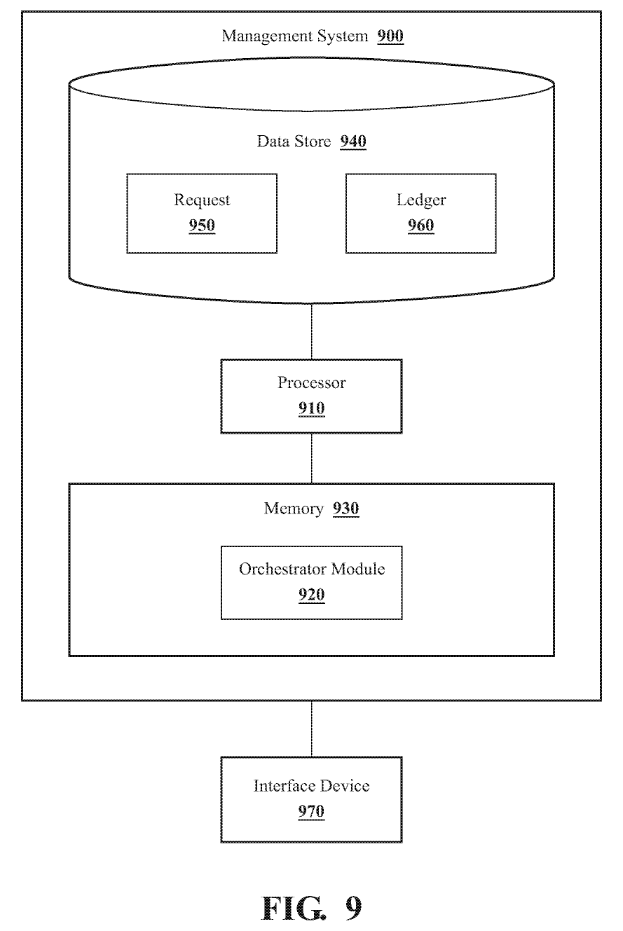

With reference to FIG. 9, one embodiment of a management system 900 is illustrated. The management system 900 is shown as including a processor 910, which may be integrated within the management system 900 or may be associated with a separate computing device, such as a server, cloud-computing system, and so on. Accordingly, the processor 910 may be a part of the management system 900, or the management system 900 may access the processor 910 through a data bus or another communication path. In one embodiment, the management system 900 includes a memory 930 that stores an orchestrator module 920. The memory 930 is a random-access memory (RAM), read-only memory (ROM), a hard-disk drive, a flash memory, or another suitable memory for storing the module 920. The orchestrator module 920 is, for example, computer-readable instructions that, when executed by the processor 910, cause the processor 910 to perform the various functions disclosed herein. In alternative arrangements, the orchestrator module 920 is independent from the memory 930 and is, for example, comprised of hardware elements (e.g., arrangements of logic gates). Thus, the orchestrator module 920 is alternatively an ASIC, a hardware-based controller, a composition of logic gates, or another hardware-based solution.

The management system 900, as illustrated in FIG. 9, is an abstracted form of the management system 900 as may be implemented as part of an edge service and/or a cloud-computing system. It should be appreciated that the functionality discussed in relation to the management system 900 may be wholly retained within a single device or may be distributed among multiple different devices, computing elements functioning as edge services, computing elements functioning as cloud services, and so on. As such, the particular arrangement described in relation to FIG. 9 is not intended to be limiting but serves as an example of how the specific functions described herein may be executed in relation to a computing device.

Continuing with FIG. 9, the data store 940 is shown as storing a request 950 and a ledger 960. In general, the orchestrator module 920 (also referred to as the orchestrator herein), functions to manage access to a pool of resources of a central test bench by way of receiving requests in the form of the request 950 and tracking the access using the ledger 960. Thus, the orchestrator module 920 and the management system 900 are generally part of a broader system that forms the central test bench. In the provided illustration, the management system 900 is shown as connecting with an interface device 970. In various arrangements, the management system 900 is operably connected with at least one interface device that provides access to one or more test devices. Of course, in further arrangements, the management system 900 may be operably connected with a plurality of interface devices and test devices.

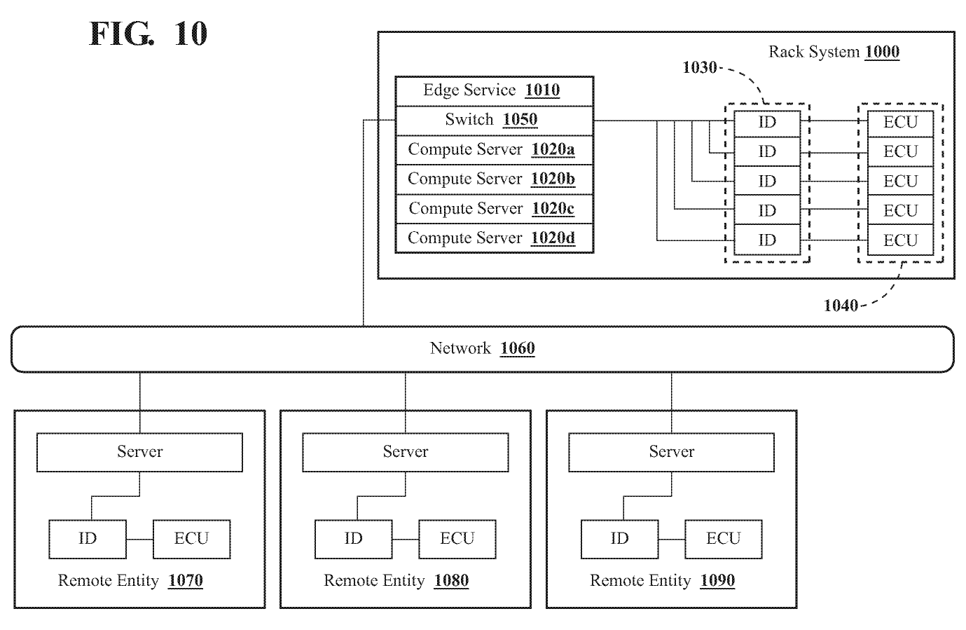

As one example of a central test bench and the broader ecosystem within which the management system 900 may be implemented, consider the arrangement of components in FIG. 10. FIG. 10 illustrates an arrangement of a rack system 1000, which may be similar to the rack system 800 of FIG. 8. In any case, as illustrated, the rack system 1000 includes an edge service, a communication switch 1050, multiple compute servers 1020a-d, and multiple interface devices 1030 connected with multiple respective test devices 1040 (e.g., ECUs). The management system 900 is embodied within the edge service 1010 in at least one configuration to manage the rack system 1000. Accordingly, the rack system 1000 is, in one arrangement, the central test bench and the resources of the central test bench include the interface devices 1030/test devices 1040 in combination with the compute serves 1020a-d. Of course, while a single rack system 1000 is illustrated, in further arrangements, the central test bench is comprised of multiple such systems that may be co-located and/or remote located.

Moreover, the compute servers 1020a-d may be implemented with different configurations. That is, for example, the compute servers 102a-d may be implanted with different types of processors (e.g., x86, arm64, etc.) to support different emulation or simulation functions. The compute servers 102a-d represent compute resources that may be used in different ways and in combination with other components, such as the ECUs 1040. In at least one configuration, the respective ones of the compute servers 102a-d implement virtualized ECUs, which may be simulated, emulated, and/or retargeted. In any case, the central test bench may implement a virtual wire harness between the different resources in order to simulate a broader system, such as a vehicle, on which tests can be performed for validation and integration or other purposes. In at least one arrangement, the virtual wire harness is implemented over a communication network and may use various protocols (e.g., UDP) to convey communications between the different components in a manner that simulates an actual wire harness.

Continuing with FIG. 10, the rack system 1000 is connected with a network 1060 via the switch 1050. The network 1060 is, in general, any communication network that permits the conveyance of information between different devices. Thus, the network 1060 may be a wide area network (WAN), local area network (LAN), and/or other networks or combinations of networks. In any case, as shown in FIG. 10, the remote entities 1070, 1080, and 1090 may communicate using the network 1060. Thus, the remote entities 1070-1090 represent additional resources that may be pooled with the resources of the rack system 1000 to permit different entities test against selected components of the testing pool.

In at least one arrangement, the rack system 1000 may provide reserved resources to one or more of the remote entities 1070-1090. The remote entities 1070-1090 themselves are generally comprised of a server/compute resource and, in at least one arrangement, at least one interface device connected with an ECU or other device under test. Of course, while a single ID and ECU are shown, it should be appreciated that the remote entity may include no ID/DUT, a single ID/DUT, or multiple IDs/DUTs in varying combinations. Thus, a remote entity, such as remote entity 1070, can provide a reservation request for a requested resource or set of resources to the orchestrator module 920, which may be implemented within the edge service 1010. The orchestrator module 920 can then reserve requested resources of a pool of available resources, which may include resources from the rack system 1000 or resources from other remote entities. Once reserved via the orchestrator module 920 selecting and tracking the resources via the ledger 960, the remote entity 1070 can initiate the reservation by providing a reservation key generated by the orchestrator module 920 at the time of the reservation.

Responsive to a request from the remote entity 1070 to begin the reservation, the orchestrator module 920 adapts routing (e.g., at the switch or within a UDP service subscription table) to integrate a test device (e.g., ECU) of the remote entity 1070 with the virtual wire harness of the central test bench. In this way, the remote test device is linked into the virtual wire harness as though it was located with the reserved resources, thereby permitting seamless testing. Additional aspects of the central test bench and the integration of the remote test device with be described further with subsequent figures.

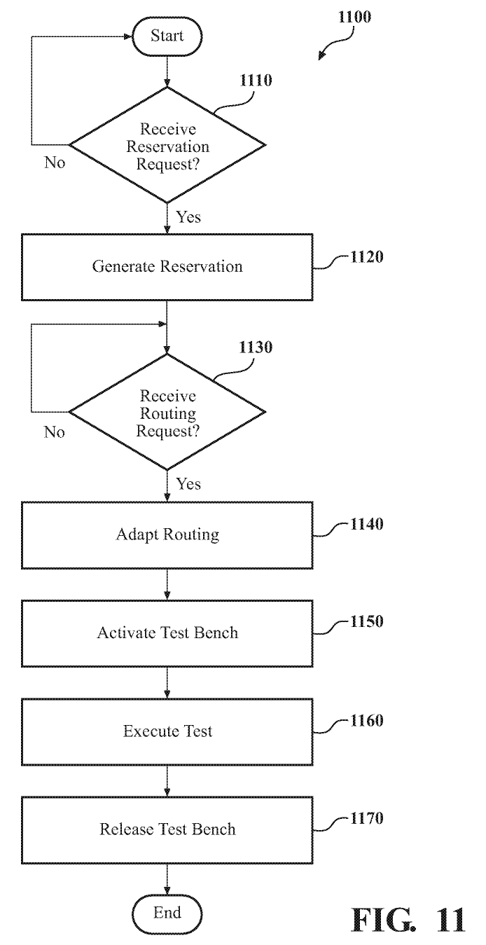

FIG. 11 illustrates a flowchart of a method 1100 that is associated with emulating a wire harness. Method 1100 will be discussed from the perspective of the management system 900 of FIG. 9. While method 900 is discussed in combination with the noted elements, it should be appreciated that the method 900 is not limited to being implemented within the management system 900 but is instead one example of a system that may implement the method 900.

At 1110, the orchestrator module 920 monitors for a request. In at least one arrangement, when the orchestrator module 920 detects a request to access resources of a central test bench, the orchestrator module 920 proceeds by parsing the request to identify salient information. For example, the request indicates which of the resources are to be reserved, and at least one remote device that is to be integrated with the central test bench. It should be appreciated that, in general, the remote device is co-located with the remote entity that provides the request. However, in further arrangements, the remote device may be located at a different location than the remote entity and/or multiple remote devices that are located separate from the central test bench and that may be located with the remote entity or not may be specified. Thus, the management system 900 permits many different arrangements of devices from different locations when forming a distributed test bench using resources of the central test bench and the remote entity.

In any case, the request serves a primary purpose of conveying attributes of a reservation to the orchestrator module 920 in order to initiate and secure a reservation. Thus, the request includes characteristics of a resource to be reserved and of a remote device that is to be integrated. Moreover, as outlined previously, the central test bench (e.g., rack system 1000) includes a pool of test devices connected via interface devices with the central test bench and further includes compute resources (i.e., virtual test devices) that are generally available as reservable resources to remote entities. This combination of resources facilitates testing configurations of software and hardware elements for hardware-in-the-loop testing, software-in-the-loop testing, and so on.

The request itself may be generated automatically by an automated testing solution at the remote entity, manually via a web-based interface to the orchestrator module 920, directly via an application programming interface (API), and so on. In any case, the request initiates a reservation and integration process that permits access to resources of the central test bench and the ultimate formation of a distributed bench.

At 1120, the orchestrator module 920 generates a reservation for the request to provide access to the requested resource. It should be appreciated that the process of generating the reservation may include multiple subcomponents depending on the particular implementation. For example, in at least one approach, the orchestrator module 920 initially uses the attributes identified previously to facilitate selecting resources from the pool of available resources. As noted, the attributes may specify various aspects about the reservation itself and the requested resources. Thus, the orchestrator module 920 uses the attributes to filter tags associated with the pool of resources. For example, in one approach, the orchestrator module 920 filters the tags by resource type, features (e.g., ECU device features), and so on. The tags generally define attributes of each distinct resource, including, for example, a serial number, model features, etc.

The orchestrator module 920 then reviews the filtered list of resources and, in at least one arrangement, selects resources that match the request. As part of selecting the resources, the orchestrator 920 may further verify the reservation by reviewing the ledger 960 for potential conflicts (i.e., existing reservations of the same resource for the same time). In general, the ledger 960 is a listing of existing reservations and attributes of the reservations that the orchestrator 920 uses to control access to the resources. In any case, when an exact match is not available, the orchestrator module 920 may provide an approximate match as an alternative or may deny the request. The approximate match may be, for example, a different time slot with a requested resource, an alternate testing device (e.g., another ECU with similar features), etc.

Once selected and verified, the orchestrator module 920 registers the reservation by, for example, adding an entry to the ledger 960 to lock the requested resource and generates a reservation key. The reservation key uniquely identifies the reservation and facilitate access to the resource. The reservation key may take different forms but is generally a hash of information associated with the reservation. The hash may be a SHA256 hash or another suitable hash. In any case, the orchestrator module 920 may generate the hash from information about the requested resource, such as an identifier, a reservation ID, an ID of the remote entity, and/or other information. Thus, the remote entity may subsequently use the reservation key as part of an authentication process when accessing the requested resource. The orchestrator module 920 can then communicate the reservation key and information about the reservation itself to the remote entity as confirmation of the reservation.

At 1130, the orchestrator module 920 monitors for a routing request from the remote entity, which functions as an initiation of the reservation. The request is identifies an address of the remote entity and the remote testing device that is to be integrated with the central test bench. The request may further include authentication information about the remote entity (e.g., an identity and passkey) along with the reservation key identifying the specific reservation. Additionally, the routing request is a request to integrate the remote device with the central test bench by modifying the virtual wire harness via an adaptation in the routing of communications between the separate entities that comprise the test bench.

At 1140, the orchestrator module 920 adapts the routing of communications at the central test bench. In at least one arrangement, the orchestrator module 920 directs the communications to the remote device to integrate the remote device with the central test bench to form a distributed bench. It should be appreciated that the virtual wire harness is generally formed between multiple separate components, which may include multiple components as the central test bench along with the remote device. Thus, in order to integrate the remote device into the virtual wire harness, the orchestrator module 920 needs to ensure that communications directed to a role that is filled by the remote device are appropriately directed to the remote device. In order to achieve this, the orchestrator module 920 re-routes the communications within the central test bench to the remote device to integrate with the requested resource.

In at least one arrangement, the orchestrator module 920 adapts routing information in a routing table, which may be embodied at the switch 1050. In further approaches, the orchestrator module 920 redefines the address of a subscription service (e.g., UDP-based service) on a network over which the virtual wire harness is implemented. This effectively defines a virtual channel between the remote device and the other components that form the virtual wire harness, which may include other remote devices along with the requested resources of the central test bench. In any case, the orchestrator module 920 re-routes the communications, which may involve directing the communications according to a configuration file of the remote device that maps pins of the remote device to ports associated with the address, thereby associating the pins with the wire harness so that the virtual wire harness can mirror the CAN/GPIO traffic to the remote device.

At 1150, the orchestrator module 920 activates the test bench. In one or more arrangements, activating the test bench involves bringing up an environment of each separate component, including virtual components and hardware components. In general, activating the test bench may involve executing one or more scripts that verify the status of each component via analysis of status messages and diagnostics. In further aspects, the orchestrator module 920 may execute commands to power components and otherwise ensure that the components are active and communicating over the virtual wire harness.

At 1160, the orchestrator module 920 executes a test on the distributed bench. In at least one arrangement, the test is a hardware-in-the-loop (HIL) simulation that executes over the requested resources and the remote device using the central test bench as the distributed bench. The particular form of the test may vary but can be a validation test, integration test, or another type of testing. In this way, the management system 900 operates to execute the test in a cohesive manner over the remote device and the requested resources of the test-specific distributed bench.

At 1170, the orchestrator module 920, upon completion of the reservation, releases the resources of the central test bench. In at least one approach, this may further involve releasing the remote device as well. That is, the reserved resources of the central test bench are locked from being used by other entities during the testing that occurs over the reservation. This lock further extends to the remote device when the remote device is part of the pool of available resources. Thus, after the reservation, the orchestration module 920 again makes the resources available to other entities in order to support testing by multiple entities. The remote device may participate in the pool of available resources such that, for example, the remote device is reserved for the local engineer during a specified timeframe on a daily basis but is returned to the pool after the reserved time. This facilitates further supplementing the pool of resources.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-11, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. The phrase “computer-readable storage medium” means a non-transitory storage medium. A computer-readable storage medium may be, for example, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system or device.

Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through a network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of … and ….” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A management system, comprising:
one or more processors;
a memory communicably coupled to the one or more processors and storing a control module, including instructions that, when executed by the one or more processors, cause the one or more processors to:
receive, within an orchestrator that controls access to resources of a central test bench, a request to access a requested resource of the resources, the request indicating which of the resources are to be reserved, and a remote device that is to be integrated with the central test bench;
generate a reservation for the request to provide access to the requested resource;
adapt routing of communications at the central test bench by directing the communications to the remote device to integrate the remote device with the central test bench to form a distributed bench; and
execute a test on the distributed bench.

2. The management system of claim 1, wherein the instructions to receive the request include instructions to receive the request from a remote entity co-located with the remote device,
wherein the request indicates attributes of a reservation including characteristics of a resource to be reserved and of the remote device that is to be integrated,
wherein the central test bench includes a pool of test devices connected via interface devices with the central test bench, and
wherein the central test bench is a cloud-based resource that implements virtual test devices and the pool of test devices to provide for testing configurations of software and hardware elements.

3. The management system of claim 1, wherein the instructions to generate the reservation include instructions to identify attributes of the requested resource that is to be reserved and selecting the requested resource from the resources of the central test bench to satisfy the attributes, and
wherein the instructions to select the requested resource include instructions to register the reservation for the requested resource to lock the requested resource and generating a reservation key to uniquely identify the reservation and facilitate access to the requested resource.

4. The management system of claim 1, wherein the instructions to adapt the routing include instructions to receive a routing request from a remote entity that holds the reservation to initiate the reservation, the routing request identifying an address of the remote entity and the remote device.

5. The management system of claim 1, wherein the instructions to adapt the routing include instructions to re-route communications within the central test bench to the remote device to mimic a wire harness of a vehicle in which the remote device is integrated with the requested resource, and
wherein the instructions to adapt the routing include instructions to re-route the communications according to a configuration file of the remote device that maps pins of the remote device to ports associated with an address of the remote entity, thereby associating the pins with the wire harness.

6. The management system of claim 1, wherein the instructions to execute the test including instructions to perform the test according to a hardware-in-the-loop (HIL) simulation that executes over the requested resource and the remote device using the central test bench as the distributed bench.

7. The management system of claim 1, wherein the instructions to execute a test on the distributed bench include instructions to use the remote device and the requested resource for the test and, once completed, returning the remote device and the requested resource to a testing pool of available resources for use by requesting entities.

8. The management system of claim 1, wherein the instructions to execute the test include instructions to implement the distributed bench to mimic one or more systems of a vehicle.

9. A non-transitory computer-readable medium including instructions that, when executed by one or more processors, cause the one or more processors to:
receive, within an orchestrator that controls access to resources of a central test bench, a request to access a requested resource of the resources, the request indicating which of the resources are to be reserved, and a remote device that is to be integrated with the central test bench;
generate a reservation for the request to provide access to the requested resource;
adapt routing of communications at the central test bench by directing the communications to the remote device to integrate the remote device with the central test bench to form a distributed bench; and
execute a test on the distributed bench.

10. The non-transitory computer-readable medium of claim 9, wherein the instructions to receive the request include instructions to receive the request from a remote entity co-located with the remote device,
wherein the request indicates attributes of a reservation including characteristics of a resource to be reserved and of the remote device that is to be integrated,
wherein the central test bench includes a pool of test devices connected via interface devices with the central test bench, and
wherein the central test bench is a cloud-based resource that implements virtual test devices and the pool of test devices to provide for testing configurations of software and hardware elements.

11. The non-transitory computer-readable medium of claim 9, wherein the instructions to generate the reservation include instructions to identify attributes of the requested resource that is to be reserved and selecting the requested resource from the resources of the central test bench to satisfy the attributes, and
wherein the instructions to select the requested resource include instructions to register the reservation for the requested resource to lock the requested resource and generating a reservation key to uniquely identify the reservation and facilitate access to the requested resource.

12. The non-transitory computer-readable medium of claim 9, wherein the instructions to adapt the routing include instructions to receive a routing request from a remote entity that holds the reservation to initiate the reservation, the routing request identifying an address of the remote entity and the remote device.

13. The non-transitory computer-readable medium of claim 9, wherein the instructions to adapt the routing include instructions to re-route communications within the central test bench to the remote device to mimic a wire harness of a vehicle in which the remote device is integrated with the requested resource, and
wherein the instructions to adapt the routing include instructions to re-route the communications according to a configuration file of the remote device that maps pins of the remote device to ports associated with an address of the remote entity, thereby associating the pins with the wire harness.

14. A method, comprising:
receiving, within an orchestrator that controls access to resources of a central test bench, a request to access a requested resource of the resources, the request indicating which of the resources are to be reserved, and a remote device that is to be integrated with the central test bench;
generating a reservation for the request to provide access to the requested resource;
adapting routing of communications at the central test bench by directing the communications to the remote device to integrate the remote device with the central test bench to form a distributed bench; and
executing a test on the distributed bench.

15. The method of claim 14, wherein receiving the request involves receiving the request from a remote entity co-located with the remote device,
wherein the request indicates attributes of a reservation including characteristics of a resource to be reserved and of the remote device that is to be integrated,
wherein the central test bench includes a pool of test devices connected via interface devices with the central test bench, and
wherein the central test bench is a cloud-based resource that implements virtual test devices and the pool of test devices to provide for testing configurations of software and hardware elements.

16. The method of claim 14, wherein generating the reservation involves identifying attributes of the requested resource that is to be reserved and selecting the requested resource from the resources of the central test bench to satisfy the attributes, and
wherein selecting the requested resource includes registering the reservation for the requested resource to lock the requested resource and generating a reservation key to uniquely identify the reservation and facilitate access to the requested resource.

17. The method of claim 14, wherein adapting the routing includes receiving a routing request from a remote entity that holds the reservation to initiate the reservation, the routing request identifying an address of the remote entity and the remote device.

18. The method of claim 14, wherein adapting the routing re-routes communications within the central test bench to the remote device to mimic a wire harness of a vehicle in which the remote device is integrated with the requested resource, and
wherein adapting the routing includes re-routing the communications according to a configuration file of the remote device that maps pins of the remote device to ports associated with an address of the remote entity, thereby associating the pins with the wire harness.

19. The method of claim 14, wherein executing the test includes performing the test according to a hardware-in-the-loop (HIL) simulation that executes over the requested resource and the remote device using the central test bench as the distributed bench.

20. The method of claim 14, wherein executing a test on the distributed bench involves using the remote device and the requested resource for the test and, once completed, returning the remote device and the requested resource to a testing pool of available resources for use by requesting entities.
